(19) United States
(12) Patent Application Publication
(10) Pub. No.: US 2010/0051458 A1
(43) Pub. Date: Mar. 4, 2010

(54) CARBON QUANTITY DETECTING SENSOR WITH INCREASED DETECTING PRECISION

(75) Inventors: Shinya TERANISHI, Kariya-shi (JP); Keigo Mizutani, Okazaki-shi (JP); Takashi Hibino, Nagoya (JP); Atsuko Tomita, Nagoya (JP)

Correspondence Address: NIXON & VANDERHYE, PC, 901 NORTH GLEBE ROAD, 11TH FLOOR, ARLINGTON, VA, 22203, US

(73) Assignees: NIPPON SOKEN, INC., Nishio-city (JP); NATIONAL UNIVERSITY CORPORATION NAGOYA UNIVERSITY, Nagoya (JP); NATIONAL INSTITUTE OF ADVANCED INDUSTRIAL SCIENCE AND TECHNOLOGY, Tokyo (JP)

(21) Appl. No.: 12/549,910

(22) Filed: Aug. 28, 2009

(30) Foreign Application Priority Data
Aug. 29, 2008 (JP) 2008-221599

(51) Int. Cl. G01N 27/26

(52) U.S. Cl. 204/424

(57) ABSTRACT

A carbon quantity detecting sensor for continuously detecting a carbon quantity of measuring gases with increased precision using a simplifier structure is disclosed. The sensor includes at least a proton conductive body composed of a solid electrolyte body having a proton conductivity, an electrode pair composed of a measuring electrode and a reference electrode formed on the proton conductive body at opposing surfaces thereof respectively, and a power source for applying at least one of a given current or a given voltage across the electrode pair. The measuring gases electrode is exposed to the measuring gases and the reference electrode is isolated from the measuring gases. This enables the carbon quantity of measuring gases to be detected with increased precision for a long period of time without causing a carbon component to accumulate on a surface of the measuring electrode due to an electrochemical reaction.

### CROSS REFERENCE TO RELATED APPLICATIONS

This application is based on Japanese Patent Application No. 2008-221599, filed on Aug. 29, 2008, the content of which is hereby incorporated by reference.

### BACKGROUND OF THE INVENTION

1. Technical Field of the Invention

The present invention relates to carbon quantity detecting sensors and, more particularly, to a carbon quantity detecting sensor used for an exhaust system of an automotive internal combustion engine to be suited for detecting a quantity of carbon contained in measuring gases.

2. Description of the Related Art

In recent years, attempts have heretofore been made to use a common rail type fuel injection system, a supercharge system, an oxidizing catalyst, a diesel particulate filter (DPF), a selective catalyst reduction (SCR) system and an exhaust recirculation (EGR) system in combination. This achieves a reduction in environmental load substances such as nitrogen oxides NOx, particulate materials PM and unburned hydrocarbons, etc., contained in combustion exhausts emitted from a diesel engine or a gasoline lean-burn engine or the like.

In general, the DPF, used in such a system, takes the form of a honeycomb structure made of a raw material such as porous ceramics having a large number of porous partition walls. The large number of porous partition walls has an infinite number of fine pores that capture PM in combustion exhausts. The PM accumulates in the fine pores, resulting in the clogging of the fine pores with a resultant increase in pressure loss. To overcome such deficiencies, attempts have heretofore been taken to heat the honeycomb structure using a burner or a heater, etc. Another attempt has been made to regenerate the DPF by performing a post injection to inject a small quantity of fuel into the engine after combustion explosion of the engine. This enables combustion exhausts with high temperatures to be introduced into the DPF for heating up the DPF, thereby combusting PM accumulated on the partition walls of the DPF for removal.

In order to have further improved combusting efficiency of the internal combustion engine, an OBD (On-board Diagnosis and an on-vehicle failure diagnosing device) for determining a timing for such a DPF to be regenerated and detecting degradation and damages to the DPF has been desired. In addition, the internal combustion has been desired to have detecting means that can continuously detect the amount of PM, contained in combustion exhausts, with high accuracy in feedback control or the like.

Patent Publication 1 (Japanese Patent Application Publication No. 2006-266961) discloses means for detecting a quantity of PM in combustion exhausts. The detecting means includes a soot detecting sensor disposed in a gas flow passage, through which gases containing soot pass, for detecting soot contained in gases. The soot detecting sensor includes a soot detecting electrode formed of an electrically conductive porous substance, and at least one pair of electrically conductive electrodes for measuring an electric current flowing through the soot detecting electrode. With such a structure, measuring the electrical resistance varying when soot is adhered onto the soot detecting electrode allows the amount of soot to be detected.

Further, Patent Publication 2 (Japanese Patent Application Publication No. 2006-322380) discloses a technology of providing an oxidizing catalyst and a thermo couple on the DPF at an upstream side and a downstream side thereof. This enables the detection of a difference between an exothermic temperature, caused by oxidizing catalyst reaction of combustion exhausts containing PM admitted to the DPF, and an exothermic temperature resulting from an oxidizing catalyst reaction of on-treated combustion exhausts passing through the DPF, thereby detecting the amount of PM in combustion exhausts.

Furthermore, Patent Publication 3 (Japanese Patent Application Publication No. 2003-513272) discloses a method of continuously monitoring chemical species and temperatures of high-temperature process gases upon using a wavelength-variable diode laser.

With the structure disclosed in Patent Publication 1, a method is carried out for measuring the resistance value varying depending on the amount of soot accumulated on the soot detecting electrode. This causes the soot detecting electrode to have a risk of deterioration in detecting sensitivity when soot is accumulated on the soot detecting electrode at a level given value or more. In addition, there is another risk of a difficulty encountered in making a distinction between a variation in resistance is value of the soot detecting electrode, caused by a variation in PM concentration of measuring gases, and a variation in resistance value of the soot detecting electrode, caused by soot accumulated on or remained on the soot detecting electrode with long-term use.

With the method relied on a differential heat as disclosed in Patent Publication 2, the differential heat is liable to an effect of a variation in combustion exhaust temperatures caused by a variation in operating condition of the internal combustion engine or an effect of a variation in flow rate of measuring gases caused by the clogging of the DPF. This causes a risk of a difficulty occurring in accurately detecting the amount of PM in combustion exhaust.

Moreover, with the method of detecting the amount of PM in combustion exhausts upon using optical means such as a semiconductor laser or the like disclosed in Patent Publication 3, there is a risk of causing a difficulty to arise for accurately performing the monitoring due to a consequence of PM in combustion exhausts being accumulated on an optical opening section for exchange of a laser light beam.

### SUMMARY OF THE INVENTION

The present invention has been completed with a view to addressing the above issue and has an object to provide a carbon quantity detecting sensor having a simplified structure to continuously detect a quantity of carbon contained in measuring gases with high precision.

To achieve the above object, a first aspect of the present invention provides a carbon quantity detecting sensor adapted to be installed in a flow passage of measuring gases containing a carbon component for detecting a carbon quantity of the measuring gases. The carbon quantity detecting sensor comprises at least a proton conductive body composed of a solid electrolyte body having a proton conductivity, an electrode pair composed of a measuring electrode and a reference electrode formed on the proton conductive body at opposing surfaces thereof, respectively, and a power source for applying at least one of a given current or a given voltage across the electrode pair. The measuring gases electrode is exposed to the measuring gases and the reference electrode is isolated from the measuring gases.

With the carbon quantity detecting sensor of the first aspect of the present invention, the electric power sources applies electric power across the electrode pair to allow an electrochemical reaction to occur on the measuring electrode to oxidize the carbon component in measuring gases while making it possible to detect the carbon quantity. This enables the realization of a carbon quantity detecting sensor that can operate with increased reliability for a long-term period without causing the carbon component, contained in measuring gases, to accumulate on the measuring electrode.

With a second aspect of the present invention, electric power is applied to the electrode pair from the power source to allow the carbon component and water vapor present in the measuring gases to be subjected to an electrochemical reaction on the measuring electrode.

With the carbon quantity detecting sensor of the second aspect of the present invention, electrolysis of water vapor present in measuring gases occurs to create active oxygen with extremely strong oxidative power, which can oxidize the carbon component present in measuring gases. This enables the realization of a carbon quantity detecting sensor that can operate with increased reliability for a long period without causing the carbon component, contained in measuring gases, to accumulate on the measuring electrode.

More particularly, as a third aspect of the present invention, the carbon quantity detecting sensor may preferably take a structure including voltage potential measuring means for measuring a voltage potential occurring across the electrode pair when applied thereto with a given electric current.

With the carbon quantity detecting sensor of the third aspect of the present invention, the voltage potential occurring across the electrode pair can be monitored at all times. This enables the carbon component, contained in measuring gases, to be accurately calculated depending on a variation in voltage potential in terms of a given current value. This enables the realization of a carbon quantity detecting sensor that can operate with increased reliability for a long-term period without causing the carbon component, contained in measuring gases, to accumulate on the measuring electrode.

More particularly, as a fourth aspect of the present invention, the carbon quantity detecting sensor may preferably take a structure including current measuring means for measuring an electric current flowing across the electrode pair when applied thereto with a given voltage.

With the carbon quantity detecting sensor of the fourth aspect of the present invention, the carbon component, contained in measuring gases, can be calculated based on the detected current value while causing a carbon component in measuring gases to be oxidized.

More particularly, like a fifth aspect of the present invention, the proton conductive body may be preferably made of pyrophosphate MP₂O₇ in which M is a tetravalent metallic cation or a tetravalent transition metal.

With the fifth aspect of the present invention, the proton conductive body exhibits proton conduction activity in a so-called intermediate temperature range of not less than 100° C. and not more than 500° C. Thus, no need arises for a heating section to be provided for activating the proton conductive body to detect the carbon quantity in high temperature fluid, serving as measuring gases, such as combustion exhausts, etc., of the internal combustion engine. This allows a carbon quantity detecting sensor to take a simplified structure with increased reliability maintained for a long period without causing carbon components, contained in measuring gases, to accumulate on the measuring electrode.

More particularly, in a sixth aspect of the present invention, the proton conductive body may preferably take a structure composed of the ABO₃ type transition metal oxide with a perovskite structure including at least one of ZrO₂ and CeO₂ while containing at least one of CaO, SrO and BaO.

With the carbon quantity detecting sensor of the sixth aspect of the present invention, the proton conductive body exhibits proton activity in a high temperature range of 500° C. or more and has high mechanical strength. When applied to a diesel particulate filter (DPF) for removing particulate matters contained in combustion exhausts emitted from a diesel engine or the like, the carbon quantity detecting sensor makes it possible to stably detect the carbon quantity even if exposed to high temperature environments of 600° C. or more during regeneration of DPF. This enables the realization of a carbon quantity detecting sensor that can operate with increased reliability for a long-term period without causing the carbon component, contained in measuring gases, to accumulate on the measuring electrode.

More particularly, in a seventh aspect of the present invention, the proton conductive body may be preferably formed of a substrate body made of stabilized zirconia having a surface a part of which is subjected to phosphate treatment to be formed with a zirconium pyrophosphate layer.

With the carbon quantity detecting sensor of the seventh aspect of the present invention, it becomes possible to allow the proton conductive body to obtain proton conductivity equivalent to that of the proton conductive body made of pyrophosphate MP₂O₇ that is difficult to be sintered. This enables the realization of a carbon quantity detecting sensor that can operate with increased reliability for a long-term period without causing the carbon component, contained in measuring gases, to accumulate on the measuring electrode.

More particularly, like an eighth aspect of the present invention, the measuring electrode and the reference electrode may preferably include porous metallic electrodes containing at least one of gold Au, platinum Pt, palladium Pd and silicon carbide SiC or cermet electrodes, respectively.

With a ninth aspect of the present invention, the carbon quantity detecting sensor may further preferably comprise a heating section for supplying the proton conductive body with electric power to heat the same to a given temperature.

With the carbon quantity detecting sensor of the ninth aspect of the present invention, the proton conductive body can operate at a stabilized temperature, thereby making it possible to detect the carbon quantity in measuring gases with further increased precision.

### BRIEF DESCRIPTION OF THE DRAWINGS

FIG. 1 is a typical schematic view showing an outline of a carbon quantity detecting sensor of a first embodiment according to the present invention.

FIG. 2 is a perspective exploded view showing an exemplary structure of a carbon quantity detecting element for use in the carbon quantity detecting sensor of the first embodiment shown FIG. 1.

FIGS. 3A to 3C are views showing test results of the carbon quantity detecting sensor of the first embodiment shown FIG. 1, with FIG. 3A representing a characteristic view showing variations in voltage potential and CO₂ concentration in terms of the presence of or absence of carbon in measuring gases, FIG. 3B representing a typical view showing an electrochemical reaction in the absence of carbon in measuring gases and FIG. 3C representing a typical view showing an electrochemical reaction in the presence of carbon in measuring gases.

FIGS. 4A and 4B are views illustrating detected results of the carbon quantity detecting sensor of the first embodiment shown FIG. 1, with FIG. 4A representing a characteristic view showing the correlationship between a carbon concentration and an output voltage potential when an applied electric current is applied, and FIG. 4B representing a characteristic view showing the correlationship between an applied current value and a detection limit.

FIG. 5 is a perspective exploded view showing an outline of a carbon quantity detecting element of a second embodiment according to the present invention.

FIG. 6 is a perspective exploded view showing an outline of a carbon quantity detecting element of a third embodiment according to the present invention.

FIG. 7 is a typical view in cross section showing an outline of a carbon quantity detecting element of a fourth embodiment according to the present invention.

FIG. 8 is a schematic typical view showing an outline of a combustion exhaust purifying system using the carbon quantity detecting element implementing the present invention.

### DETAILED DESCRIPTION OF PREFERRED EMBODIMENTS

### First Embodiment

Now, a carbon quantity detecting element 10 of a first embodiment according to the present invention and a carbon quantity detecting sensor 1, incorporating such a detecting element, will be described below with reference to the accompanying drawings. However, the present invention is construed not to be limited to such an embodiment described below and technical concepts of the present invention may be implemented in combination with other known technologies or other technologies having functions equivalent to such known technologies.

The carbon quantity detecting sensor 1 of the present embodiment can be utilized for various purposes. That is, the resulting detected value is used for accurately for determining a timing at which a DPF (Diesel Particulate Filter) is to be regenerated. Further, the resulting detected value is used for detecting the occurrence of degradation in performance of the DPF. Furthermore, the resulting detected value is used for OBD (On-board failure self-diagnosing device) with which a breakage or the like is determined. In addition, the resulting detected value is used for performing rich spike control or the like in which fuel is injected to combustion exhausts to achieve a reduction in PM and NOx.

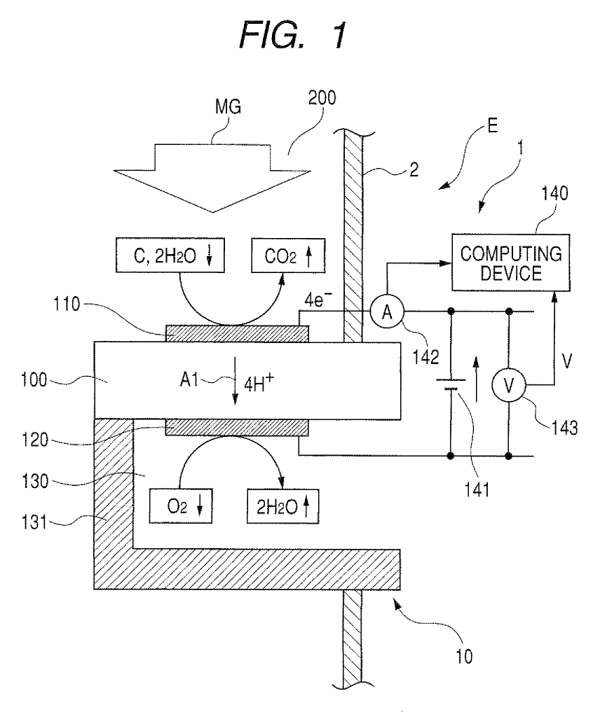

As shown in FIG. 1, the carbon quantity detecting sensor 1 of the first embodiment according to the present invention is fixedly mounted on a measuring gas flow passage wall 2 of an internal combustion engine E. This allows the carbon quantity detecting element 10 to have a measuring section placed inside an exhaust gas flow passage 200 to detect combustion exhausts, emitted from the internal combustion engine, as measuring gases.

The carbon quantity detecting element 10 includes a proton conductive body 100 formed in a plate-like configuration using a solid electrolyte material with proton conductivity. The proton conductive body 100 has one surface, formed with a measuring electrode 110, and the other surface formed with a reference electrode 120 placed in opposition to the measuring electrode II 0, thereby forming an electrode pair.

The measuring electrode 110 is exposed to the flow of measuring gases. However, the reference electrode 120 is covered with a proton discharge channel-forming layer 131 in which a proton discharge channel 130 is defined in a structure isolated from measuring gases.

The measuring electrode 110 is connected to a positive electrode of a DC power source 141 having a negative electrode connected to the reference electrode 120. When a given DC voltage is applied across the electrode pair composed of the measuring electrode 110 and the reference electrode 120, an electric current flows across the electrode pair and current detecting means 142 is connected the electrode pair to detect the electric current flowing therebetween. In an alternative, voltage detecting means 143 is connected between the electrode pair to detect a voltage developed across the same. In addition, a computing device 140 is connected to the current detecting means 142 and the voltage detecting means 143 to calculate a carbon quantity in measuring gases based on a detected result from the current detecting means 142 or the voltage detecting means 143.

Combustion exhausts, emitted from the internal combustion engine E and serving as measuring gases, contain granular particulate matter PM, composed of soot and unburned hydrocarbon (HC), soluble organic fractions (SOF) and sulfur oxides or the like, and, in addition thereto, water vapor (H₂O) in the form of a combustion product of fuel.

With a given DC voltage being applied across the electrode pair comprised of the measuring electrode 110 and the reference electrode 120, a reaction takes place in a manner as shown in a formula 1 described below. In this moment, an electrochemical reaction of water vapor occurs on of the measuring electrode 110 to generate active oxygen, which in turn causes carbon in PM to combust for generating carbon dioxide.

C+2H₂O→CO₂+4H⁺+4e⁻ Formula 1

It turns out that during such a reaction, hydrogen ions move through the proton conductive body 100 to permit an electric current I to flow across the electrode pair or a voltage V to develop across the electrode pair at rates correlated with a carbon quantity decomposed on the surface of the measuring electrode 110.

Accordingly, using the current I flowing across the electrode pair or the voltage V developed across the electrode pair, detected by the current detecting means 142 or the voltage detecting means 143, results in a capability of detecting an exact quantity of carbon decomposed on the measuring electrode 110, i.e., a concentration of PM present in measuring gases.

Further, hydrogen ions, generated on the electrochemical reaction of water vapor, migrate through the proton conductive body 100 toward the reference electrode 120 in a direction as indicated by an arrow A1 in FIG. 1 for reaction with oxygen in atmospheric air admitted to the proton discharge channel 130. This results in the formation of H₂O, which is discharged to the outside of the proton discharge channel 130.

With the carbon quantity detecting sensor 1 of the present embodiment, carbon, contained in PM placed in contact with a surface of the measuring electrode 110, is oxidized with active oxygen species O* having an extremely strong oxidative power resulting from the electrochemical reaction. Thus, no risk occurs for causing degradation in sensor function due to the accumulation of PM on a sensor surface as encountered in the related art PM sensor.

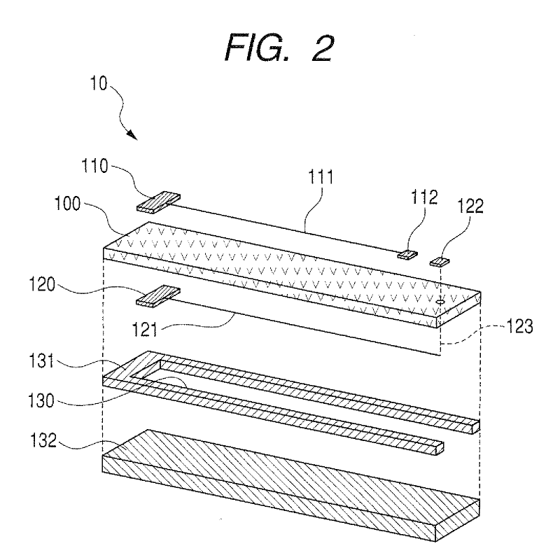

A more concrete structure of the carbon quantity detecting element 10 of the first embodiment according to the present invention and an outline of a method of manufacturing the same will be described below with reference to FIG. 2.

With the present embodiment, the proton conductive body 100 includes a solid electrolyte preferably made of pyrophosphate MP₂O₇ (M represents tetravalent cation) and, more particularly, made of stannum pyrophosphate Sn_{0.9}In_{0.1}P₂O₇ to which indium was doped.

Sn_{0.9}In_{0.1}P₂O₇ has a high proton defect concentration and exhibits high proton conductivity in a so-called intermediate temperature range at temperatures of 500° C. or less. With the carbon quantity detecting element 10 placed in the combustion exhaust passage 2 of the internal combustion engine E, the carbon quantity detecting element 10 can be easily activated with combustion exhaust temperatures. This makes it possible to obtain proton conductivity with no need to provide specific means for heating the proton conductive body 100. This results in a capability of achieving a simplification in element.

Further, the proton conductive body 100 is formed in a substantially plate-like configuration by a known ceramic forming method such as a doctor-blade method and a press-forming method or the like.

The proton conductive body 100 has one surface formed with the measuring electrode 110, a measuring electrode lead portion 11, a measuring electrode terminal portion 112, and a reference electrode terminal portion 122. The proton conductive body 100 has the other surface formed with the reference electrode 120 and a reference electrode lead portion 121. The reference electrode lead portion 121 and the reference electrode terminal portion 122 are connected via a through-hole electrode 123 extending through the proton conductive body 100 at one end thereof.

Further, the measuring electrode 110 and the reference electrode 120 are composed of porous metal electrodes each containing one of gold Au, platinum Pt, palladium Pd and silicon carbide SiC or cermet electrodes, which can be formed by a known electrode forming method such as thick-film printing, vapor deposition or plating or the like.

The measuring electrode lead portion 111, the measuring electrode terminal portion 112, the reference electrode lead portion 121, the reference electrode terminal portion 122 and the through-hole electrode 123 are made of materials containing metal with high electric conductivity and formed by a known electrode forming method such as thick-film printing, vapor deposition or plating or the like.

The proton discharge channel-forming layer 131 and a basic bottom layer 132 are stacked on the other surface of the proton conductive body 100 in this order so as to face the reference electrode 120.

The proton discharge channel-forming layer 131 and the basic bottom layer 132 are made of insulating ceramics such as, for instance, alumina Al₂O₃ or the like and each formed in a substantially plate-like configuration by the known ceramic forming method such as the doctor-blade method and the press-forming method or the like.

The proton discharge channel-forming layer 131 includes a flat plate a part of which is cut away to form the flat plate in a substantially U-shape configuration with the proton discharge channel 130 being formed in a central area of the flat plate.

The proton conductive body 100, formed with the measuring electrode 110 and the reference electrode 120, the proton discharge channel-forming layer 131 and the basic bottom layer 132 are stacked on each other into a unitary stack body, which is then subjected to a firing process. This enables the formation of a unitized carbon quantity detecting element 10.

Further, while the present embodiment has been described with reference to an example of using indium as dopant for the proton conductive solid electrolyte, it can be speculated that even using aluminum results in a consequence of obtaining a proton conductive solid electrolyte similar to the proton conductive solid electrolyte using indium.

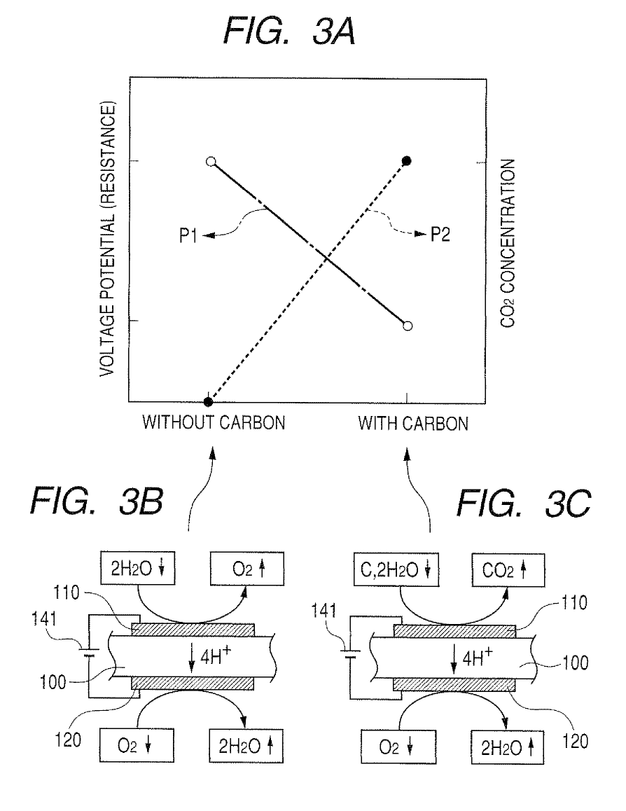

Test results on the carbon quantity detecting sensor 1 of the first embodiment according to the present invention is described below with reference to FIG. 3.

In conducting tests, moistening helium containing 3% of water vapor and 10% of oxygen was used as measuring-gas simulating combustion exhausts of an internal combustion engine. Moistening helium was supplied to the measuring electrode 110 at a given temperature (of, for instance, 200° C.) and the measuring electrode 110 was applied with electric power from the DC power source 141 to allow a given current I (of, for instance, 10 mV) to flow. Under such a condition, a test was conducted to measure a voltage potential V occurring across the electrode pair and an analysis was conducted using a gas chromatography to check components in gaseous matter created on the measuring electrode 110.

Test pieces were prepared one for the measuring electrode 110 having a surface coated with carbon and the other for the measuring electrode 110 having a surface uncoated with carbon and used to make a comparison between differences in voltage potential V and generated gaseous matters due to the presence of or absence of PM in measuring gases.

As shown in FIG. 3A, when no carbon was present in measuring gases, the carbon quantity detecting sensor 1 of the first embodiment according to the present invention detected the voltage potential V with a high level wherein no carbon dioxide was detected on the measuring electrode 110 with only oxygen being detected. On the contrary, when carbon was present in measuring gases, the carbon quantity detecting sensor 1 of the first embodiment according to the present invention exhibited the voltage potential V with a low value as indicated by a single-dotted line P1. It was turned out that a significant amount of carbon dioxide for the coated carbon and a small amount of oxygen were detected and carbon dioxide carbon was completely oxidized. A broken line P2 represents a variation in voltage potential detected by a carbon quantity detecting sensor of the related art.

Under a situation where no carbon is present in measuring gases, it is speculated, as shown in FIG. 3B, that an electrolysis reaction takes place on the measuring electrode 110. This causes water vapor H₂O to be decomposed into oxygen ion O²⁻ and hydrogen ion H⁺ with oxygen ion O₂ being immediately converted to an oxygen molecule O₂. The hydrogen ion H⁺ migrates through the proton conductive body 100 to the reference electrode 120 to react with oxygen molecule O₂ present in the proton discharge channel 130 to form water which is discharged.

Meanwhile, under a situation where carbon is present in measuring gases, it is estimated that an electrolysis reaction takes place on the measuring electrode 110 to cause water vapor H₂O to be decomposed into active oxygen species O* and hydrogen ion H⁺, as shown in FIG. 3C, wherein active oxygen species O* having a strong oxidative power, oxidizes carbon coated on the surface of the measuring electrode 110 the hydrogen ion H⁺ migrates through the proton conductive body 100 to the reference electrode 120 to react with oxygen molecule O₂ to form water which is discharged.

Further, Raman spectroscopic analysis was conducted to directly observe a process in which carbon was oxidized on the measuring electrode 10 and it was confirmed that permitting the flow of electric current I resulted in the demonstration of absorption attributed to O₂²⁻ at about 900 cm⁻¹. This suggests that a surface active oxygen species occurring on the measuring electrode 110 is O₂²⁻.

When applying the electric current I with a given value across the electrode pair, a remarkably increased variation takes place in the voltage potential V detected in terms of the presence of or absence of carbon in measuring gases. Therefore, using the carbon quantity detecting sensor 1 of the present embodiment makes it possible to monitor a variation in PM quantity in measuring gases upon measuring the voltage potential.

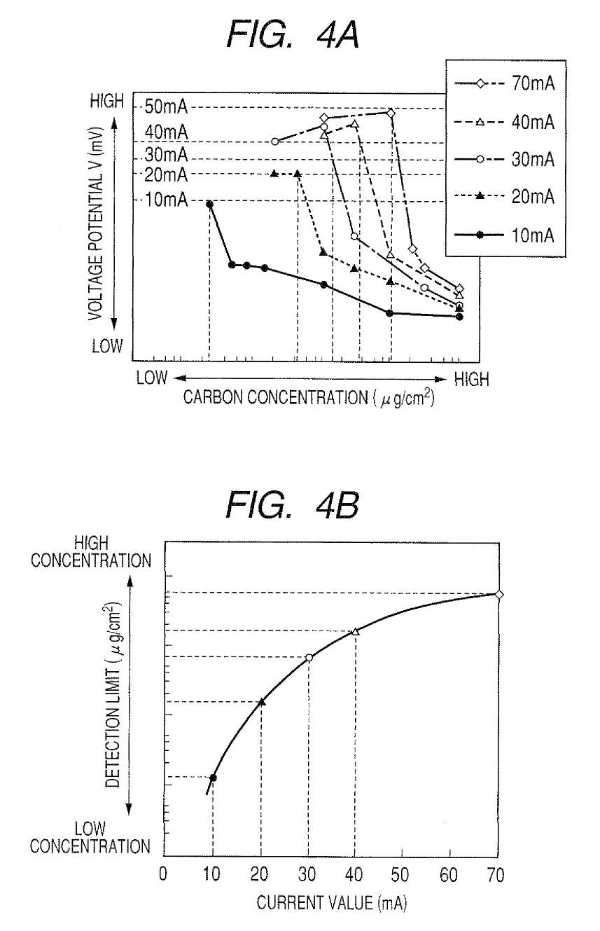

Referring to FIGS. 4 to 4C, description is provided of the variation in voltage potential V with variations in electric current I applied across the electrode pair the carbon quantity detecting sensor 1 of the present embodiment and a carbon quantity on the surface of the measuring electrode 110.

As shown in FIG. 4A, it tuned out that there were one carbon quantity region in which carbon was instantaneously oxidized in the presence of the electric current I to cause the voltage potential to increase to a high level (with high resistance) and the other carbon quantity region in which it took much time for carbon to be oxidized while sustaining a low voltage potential (with low resistance).

Further, it tuned out that the voltage potential V exhibited a high voltage potential in the absence of carbon on the measuring electrode 110 and, as shown in FIG. 4B, there were different detecting limits depending on the current I.

Accordingly, it is expected that a carbon quantity detecting sensor can be realized with a capability of having further increased detecting precision and response. This can be achieved upon correcting a detection result of the carbon quantity detecting sensor 1 of the present embodiment by adjusting the current I in accordance with the quantity of PM present in combustion exhaust to obtain a corrected detection result. This allows a combustion control of an internal combustion engine to be executed with further increased precision upon using the corrected detection result, while the corrected detection result can be utilized for determining regenerative timing of a DPF.

### Second Embodiment

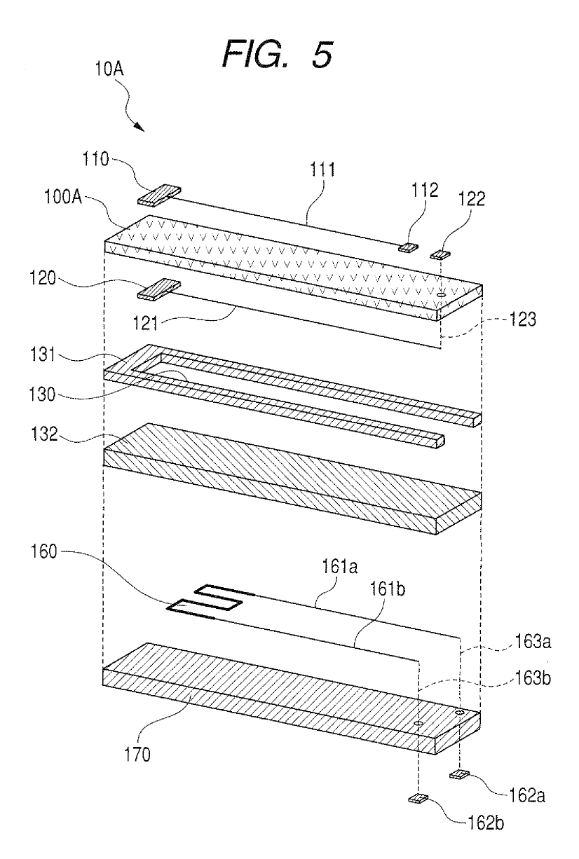

FIG. 5 shows a carbon quantity detecting element 10A of a second embodiment according to the present invention. The carbon quantity detecting element 10A of the second embodiment differs from the carbon quantity detecting element 10 of the first embodiment in features as described below. That is, the proton conductive body 100 of the first embodiment composed of the solid electrolyte of the MP₂O₇ type, exhibiting the proton activity in the middle temperature range at temperatures of 100° C. or more and 500° C. or less, is replaced by a proton conductive body 100A of a structure employing ABO₃ type transition metal oxide with a perovskite structure exhibiting a proton activity even in a high temperature range of 500° C. or more. In addition, the carbon quantity detecting element 10A of the second embodiment further includes a heater section for heating the proton conductive body 110A.

With the present embodiment, the proton conductive body 100A can be formed of the ABO₃ type transition metal oxide with the perovskite structure that takes the form of a principal component of either ZrO₂ or CeO₂ and includes either one of CaO, SrO and BaO. For instance, SrZrO₃ or the like may be preferably used and the proton conductive body 100A is formed in a sheet-like configuration using such a proton conductive body electrolyte material. Moreover, the proton conductive body 100A can be formed by the known ceramic forming method such as the doctor-blade method and the press-forming method, etc.

With the present embodiment, the carbon quantity detecting element 10A further includes heater section composed of a heating substrate 170. The heating substrate 170 has one surface, facing the basic bottom layer 132 stacked on the proton conductive body 100A, which is formed with a heating element 160 at one end portion of the heating substrate 170 and heating lead portions 161a and 161b extending from terminal ends of the heating element 160 in parallel to each other. The heating lead portions 161a and 161b end at the other end portion of the heating substrate 170 to be connected to ends of heating through-holes 163a and 163b, extending through the heating substrate 170, whose other ends are electrically connected to heating element terminals 62a and 62b formed on the surface of the heating substrate 170. The substrate 170, formed in such a structure, is stacked onto a lower surface of the proton conductive body 100A via the basic bottom layer 132, defining a part of the proton discharge channel 130, resulting in a unitary structure. The unitary structure is then subjected to firing, thereby forming the carbon quantity detecting element 10A in a unitized structure.

With the present embodiment, the heating element 160 is connected to an external power source via the heating element terminals 162a and 62b, the heating through-holes 163a and 163b and the heating element lead portions 161a and 161b. When applied with electric power, the heating element 160 develops a heat at high temperatures thereby activating the proton conductive body 100A. This enables the carbon quantity detecting element 10A of the present embodiment to stably detect a carbon quantity like the carbon quantity detecting element 10 of the first embodiment even when using the proton conductive solid electrolyte of the high temperature type.

### Third Embodiment

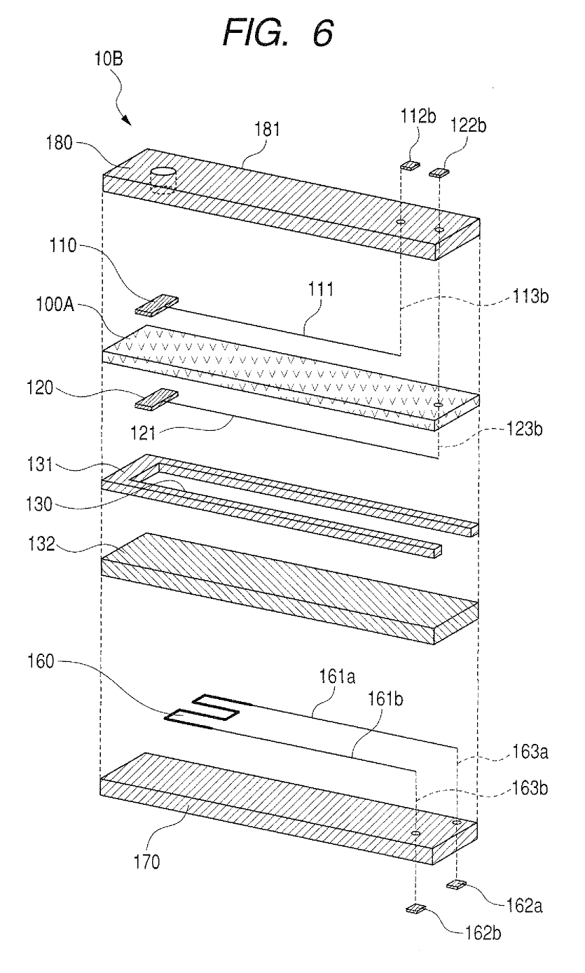

A carbon quantity detecting element 10B of a third embodiment according to the present invention is described with reference to FIG. 6. The carbon quantity detecting element 10B of the third embodiment differs from the carbon quantity detecting element 10 of the first embodiment or the carbon quantity detecting element 10A of the second embodiment in that a diffusion resistance forming layer 180 is stacked on the proton conductive body 100 of the carbon quantity detecting element 10 of the first embodiment or the proton conductive body 100A of the carbon quantity detecting element 10A of the second embodiment such that as bottom wall of the diffusion resistance forming layer 180 faces the measuring electrode 110. The diffusion resistance forming layer 180 has one end portion formed with a diffusion resistance layer 181 formed in alignment with the measuring electrode 110 in a stack direction of carbon quantity detecting element 10B. The diffusion resistance layer 180 serves to restrict the flow of measuring gases admitted to the measuring electrode 110.

With the present embodiment, the diffusion resistance forming layer 180 has the other end portion having one surface formed with a measuring electrode portion 112b and a reference electrode terminal portion 122b in areas longitudinally spaced from each other. With a view to applying electric power to the measuring electrode 110, the diffusion resistance forming layer 180 is formed with a through-hole electrode 113b for electrical connection between the measuring electrode terminal portion 112b and the measuring electrode lead portion 111 connected to the measuring electrode 110. Likewise, with a view to applying electric power to the reference electrode 120, the diffusion resistance forming layer 180 and the proton conductive body 100A are formed with a through-hole electrode 123b for electrical connection between the reference electrode terminal portion 112b and the reference electrode lead portion 121 connected to the reference electrode 120.

The diffusion resistance layer 181 has an effect of restricting the flow of measuring gases applied to the surface of the measuring electrode 110, thereby restricting the amount of PM oxidized on the measuring electrode 110. This allows the carbon quantity detecting element 10B to have a structure of a so-called limited current measuring type and it can be expected to realize a carbon quantity detection with further increased precision.

### Fourth Embodiment

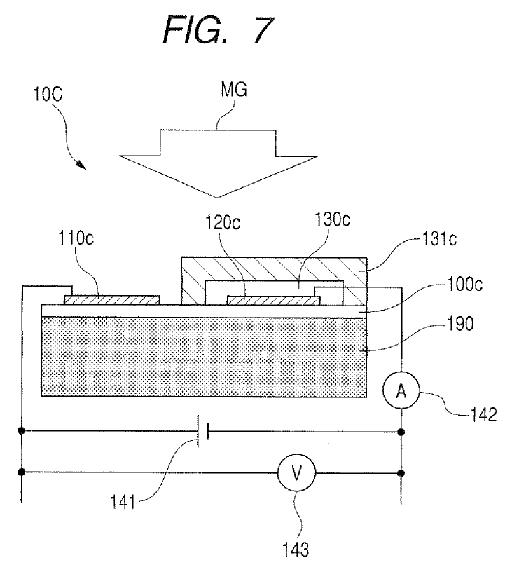

A carbon quantity detecting element 10C of a fourth embodiment according to the present invention is described with reference to FIG. 7. FIG. 7 is a cross sectional view showing the carbon quantity detecting element 10C of the present embodiment placed in an area exposed to a stream of measuring gases. With the carbon quantity detecting element 10 of the first embodiment, the proton conductive body 100 carries thereon the electrode pair such that the electrodes sandwich the proton conductive body 100. The proton conductive body electrolyte of the MP₂O₇ is a material that is difficult to be sintered. This results in a difficulty of obtaining a sintered body configured in a plate-like shape like that shown with reference to the first embodiment, causing a risk of and increase in production cost. To avoid such a difficulty, the present embodiment contemplates the provision of the carbon quantity detecting element 10C composed of a substrate body 190 composed of stabilized ZrO₂, having excellent mechanical strength, which is known as an oxygen conductive solid electrolyte. The substrate body 190 has one surface a part of which is subjected to phosphate treatment to be formed with a zirconium pyrophosphate layer 100c. The zirconium pyrophosphate layer 100c has one surface on which a measuring electrode 110c and a reference electrode 120c are formed in a spaced relationship with only the measuring gases electrode 110c being exposed to a stream of measuring gases MG. A proton discharge channel-forming layer 131c is disposed on the surface of the zirconium pyrophosphate layer 100c to cover the reference electrode 120c such that a proton discharge channel 100c is defined.

With the carbon quantity detecting element 10C formed in such a structure, the zirconium pyrophosphate layer 100c, formed over the surface of the substrate body 190, exhibits a proton conductive body, thereby making it possible to realize the carbon quantity detecting element 10C with high precision like the carbon quantity detecting element 10 of the first embodiment. In addition, the carbon quantity detecting element 10C of the present embodiment may further include the same heating structure as that of the second embodiment.

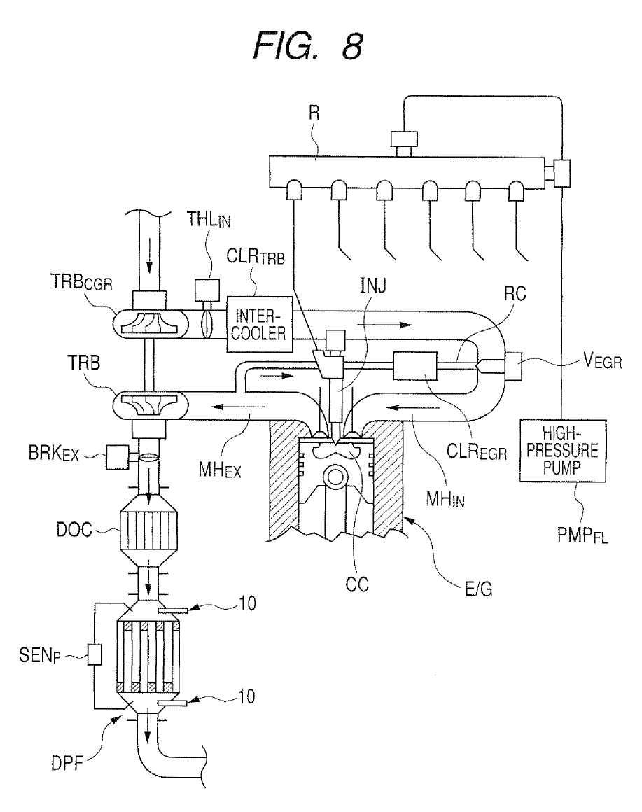

An outline of an exhaust gas purifying system having the carbon quantity detecting sensor of the present invention applied to a diesel engine E/G will be described below with reference to FIG. 8. The diesel engine E/G is a direct-injection type diesel engine that includes a high-pressure pump PMP_{FL} arranged to accumulate high-pressure fuel in a common rail R to allow an injector INJ to directly inject pressure into a combustion chamber CC of the diesel engine E/G.

The diesel engine E/G has an exhaust manifold MH_{EX} in which a turbine TRB is mounted to be drive with a stream of exhaust gases. The turbine TRB is connected to a supercharger TRB_{CGR}, which is rotatably driven compress a flow of intake air to be admitted to an inter cooler CLR_{TRB} by which the flow of intake air is cooled to allow a stream of cooled intake air to be admitted to an intake manifold MH_{IN}. A part of combustion exhaust, discharged from the exhaust manifold MH_{EX}, is recirculated through a recirculation passage RC to the intake manifold MH_{IN} for improving a combusting efficiency. Combustion exhaust, discharged from the exhaust manifold MH_{EX}, passes through an oxidizing catalyst DOC in which unburned hydrocarbon HC, carbon monoxide CO and nitric monoxide NO are oxidized. Exhaust gas, thus subjected to oxidizing treatment, is caused to further pass through a diesel particulate filter DPF by which particular matters PM are removed. In addition, combustion exhaust is delivered through a selective catalyst reduction SCR, (not shown) to convert NOx into innoxious compounds such as N₂ and H₂O in reduction to be exhausted to the outside.

The diesel particulate filter DPF has an inlet and an outlet on which the carbon detecting elements 10 of the present invention are mounted. These carbon detecting elements 10 monitor the amount of PM contained in combustion exhaust at all times, with detected outputs being utilized for the DPF to be controllably regenerated and for OBD (On-board failure self-diagnosing device).

The present invention is construed not to be limited to the embodiments set forth above and may be implemented in various modes without departing from the scope of the present invention.

For instance, the present embodiments have been described above with reference to the example of the carbon quantity detecting sensor installed on the internal combustion engine such as an automotive engine or the like. However, the carbon quantity detecting sensor of the present invention can be utilized for application to a large-scale plant of a thermal power station or the like for detecting a quantity of carbon.

Furthermore, by controlling an electric current flowing across an electrode pair in a pulsed current that can vary in a cyclic manner, further increased detecting precision and improved response can be expected.

In addition, while the present embodiments have been described above with reference to an example of a so-called stack type sensing element structure, an alternative may include a so-called cup type sensing element structure having a proton conductive body formed in a bottomed cylindrical configuration having an outer wall and an inner wall formed with electrode layers, respectively.

What is claimed is:

1. A carbon quantity detecting sensor adapted to be installed in a flow passage of measuring gases containing a carbon component for detecting a carbon quantity of the measuring gases, the carbon quantity detecting sensor comprising:
at least a proton conductive body composed of a solid electrolyte body having a proton conductivity, an electrode pair composed of a measuring electrode and a reference electrode formed on the proton conductive body at opposing surfaces thereof respectively; and
a power source for applying at least one of a given current or a given voltage across the electrode pair; wherein
the measuring gases electrode is exposed to the measuring gases and the reference electrode is isolated from the measuring gases.

2. The carbon quantity detecting sensor according to claim 1, wherein:
an electric power is applied to the electrode pair from the power source to allow the carbon component and water vapor present in the measuring gases to be subjected to an electrochemical reaction on the measuring electrode.

3. The carbon quantity detecting sensor according to claim 1, further comprising:
voltage potential measuring means for measuring a voltage potential occurring across the electrode pair when applied thereto with a given electric current.

4. The carbon quantity detecting sensor according to claim 1, further comprising:
current measuring means for measuring an electric current flowing across the electrode pair when applied thereto with a given voltage.

5. The carbon quantity detecting sensor according to claim 1, wherein:
the proton conductive body is made of pyrophosphate MP₂O₇ in which tetravalent metallic cation or a tetravalent transition metal.

6. The carbon quantity detecting sensor according to claim 1, wherein:
the proton conductive body is made of ABO₃ type transition metal oxide with a perovskite structure having a principal component including at least one of ZrO₂ and CeO₂ while containing at least one of CaO, SrO and BaO.

7. The carbon quantity detecting sensor according to claim 1, wherein:
the proton conductive body is formed of a substrate body made of stabilized zirconia having a surface a part of which is subjected to phosphate treatment to be formed with a zirconium pyrophosphate layer.

8. The carbon quantity detecting sensor according to claim 1, wherein:
the measuring electrode and the reference electrode include porous metallic electrodes containing at least one of gold Au, platinum Pt, palladium Pd and silicon carbide SiC or cermet electrodes, respectively.

9. The carbon quantity detecting sensor according to claim 1, further comprising:
a heating section for supplying the proton conductive body with electric power to heat the same to a given temperature.
